(19) United States
(12) Patent Application Publication
(10) Pub. No.: US 2010/0017063 A1
(43) Pub. Date: Jan. 21, 2010

(54) ELECTRIC POWER STEERING APPARATUS

(75) Inventor: Masahiro Maeda, Maebashi-shi (JP)

Correspondence Address: SUGHRUE-265550, 2100 PENNSYLVANIA AVE. NW, WASHINGTON, DC, 20037-3213, US

(73) Assignee: NSK, Ltd., Tokyo (JP)

(21) Appl. No.: 12/443,699

(22) PCT Filed: Jun. 25, 2008
(86) PCT No.: PCT/JP2008/061583

§ 371 Date: Mar. 31, 2009

(30) Foreign Application Priority Data
Jun. 29, 2007 (JP) 2007-172387

(51) Int. Cl. G06F 19/00; H02P 6/08; H02P 21/00; B62D 6/00

(52) U.S. Cl. 701/42; 318/400.09; 318/400.02

(57) ABSTRACT

An electric power steering apparatus in which the intensity and directions of drive currents flowing in remaining phases continues motor rotation driving. An abnormality detect unit (27) detects a conduction abnormality in drive systems for the respective phase coils of the 3-phase brushless motor (12). A steering assisting current command value calculating unit (31) calculates a steering assisting current command value. A normal time motor command value calculating unit (33) calculates three phase current command values according to the steering assisting current command value. An abnormal time motor command value calculating unit (34) calculates two phase current command values for using the two remaining phase coils. A command value select portion (35) selects the phase current command values calculated by the normal or abnormal time motor command value calculating unit. A motor control unit (36) drives the electric motor (12) according to the selected phase current command value.

### TECHNICAL FIELD

The present invention relates to an electric power steering apparatus including a 3-phase brushless motor having three star-connected phase coils for generating a steering assisting force for a steering system, and steering assisting control means which drives and controlling the 3-phase brushless motor according to a steering torque to be transmitted to the steering system.

### BACKGROUND ART

In this type of electric power steering apparatus, when an abnormality has occurred in a motor drive circuit, such an abnormality is dealt with by a fail-safe function which cuts off electric energization between the motor drive circuit and a brushless motor through switching means such as a relay. In this case, surely, since a braked state of the brushless motor can be recovered by the cutoff function of the switching means such as a relay, that is, in that case, the steering system becomes an ordinary manual steering system not having an electric power steering apparatus, the steering by a driver is possible, which makes it possible to avoid a possibility that a vehicle is unable to run.

However, when the steering system is shifted to the manual steering system, a steering force necessary for the steering operation increases greatly, thereby raising a problem that the driver receives strange feeling greatly and the state of steering by the driver becomes awkward until the driver becomes used to such steering operation.

In order to solve the above problem, there is known an electric power steering apparatus (Patent Reference 1). In the electric power steering apparatus, for example, a certain number, which corresponds to the number of phases of a 5-phase brushless motor, of series circuits each including two field effect transistors connected in series to each other are connected parallel to each other to constitute an FET circuit, the connecting points of the field effect transistors of the respective series circuits are connected through a non-conduction detect circuit to the other ends of the respective star-connected phase coils and, when the non-conduction detect circuit detects an abnormality that one of the respective phases is non-conducting, a drive current flowing in the brushless motor can be reduced in amount when compared with the normal state of the phases, whereby, even when one of the phases of the brushless motor happens to be non-conducting, the driving of the brushless motor can be continued so as to be able to prevent the steering operation from becoming heavy.

Patent Reference 1: Japanese Patent Unexamined Publication JP-A-10-181617 (Page 1, FIG. 2)

### DISCLOSURE OF THE INVENTION

Problems that the Invention is to Solve

However, according to the electric power steering apparatus disclosed in the above-mentioned patent reference 1, in the 5-phase brushless motor, even when the drive current is reduced, the rotational driving of the brushless motor is possible. However, in a 3-phase brushless motor, when one of the three phases becomes non-conducting and abnormal, even if trying to drive the motor by electrically energizing only the two remaining phases, the magnetic field vector generated in the inside of the motor cannot be rotated, which makes it impossible to rotate the motor. Also, even when the 3-phase brushless motor can be rotated using an external force such as a steering force, the pulsation of a torque generated by the motor is large, which provides a driver a seriously strange feeling. This shows that, in the conventional power steering apparatus, there is left a problem to be solved.

In view of this, the present invention aims at solving the above-mentioned problem found in the conventional electric power steering apparatus. Thus, it is an object of the invention to provide an electric power steering apparatus which, when an abnormality occurs in one of the three phases of a 3-phase brushless motor, can control the intensity and direction of a drive current flowing in the two remaining phases to thereby be able to continue the driving and rotation of the 3-phase brushless motor.

### Means for Solving the Problems

In attaining the above object, according to the invention as set forth in first aspect of the invention, there is provided an electric power steering apparatus, including:

a 3-phase brushless motor including star connected phase coils for generating steering assisting force for a steering system;

steering torque detect means which detects a steering torque to be transmitted to the steering system; and,

steering assisting control means which calculates a steering assisting current command value according to the steering torque detected by the steering torque detect means, and which drives and controls the 3-phase brushless motor according to the thus calculated steering assisting current command value,

wherein the steering assisting control means includes:

coil drive system abnormality detect means which detects a conduction abnormality of drive systems for the respective phase coils;

steering assisting current command value calculating means which calculates the steering assisting current command value according to the steering torque;

normal time motor command value calculating means, when the coil drive system abnormality detect means does not detect the abnormality of the drive systems for the respective phase coils, which calculates a phase current command value for using the three phase coils according to the steering assisting current command value;

abnormal time motor command value calculating means, when the coil drive system abnormality detect means detects a conduction abnormality in one of the drive systems for the respective phase coils, which calculates a phase current command value for using the two remaining phase coils according to the steering assisting current command value;

command value select means which selects the phase current command value calculated by the normal time motor command value calculating means or the phase current command value calculated by the abnormal time motor command value calculating means; and,

motor control means which drives the 3-phase brushless motor according to the phase current command value selected by the command value select means.

Also, according to the invention as set forth in a second aspect of the invention, there is provided the electric power steering apparatus as set forth in the first aspect of the invention, further including:

conduction cutoff means interposed between the drive systems for the respective phase coils and capable of cutting off conduction between the phase coil drive systems; and,

cutoff control means, when the coil drive system abnormality detect means detects the conduction abnormality in one of the phase coil drive systems, which controls the conduction cutoff means, which is interposed between the drive systems including the drive system detected abnormal, to cut off conduction between these drive systems.

Further, according to the electric power steering apparatus as set forth in a third aspect of the invention, the electric power steering apparatus as set forth in the first or second aspect of the invention, wherein

the abnormal time motor command value calculating means, when controlling the two phase coils into conduction, sets the phase current command value as a function of a rotor angle.

Still further, according to the electric power steering apparatus as set forth in a fourth aspect of the invention, the electric power steering apparatus as set forth in any one of the first to third aspect of the invention, further including:

electric angle information calculating means which detects a motor rotation angle to calculate an electric angle and an electric angular velocity,

wherein the normal time motor command value calculating means includes at least:
a d-axis current setting means which sets a d-axis current;
a d-q voltage calculating means which calculates a d-axis voltage and a q-axis voltage while referring to a 3-phase driving memory table expressing a relationship between d-axis voltage, q-axis voltage and electric angle respectively obtained by converting electromotive force waveforms of three coils to a rotor rotation coordinate system; and,
q-axis current calculating means which calculates a q-axis current according to the steering assisting current command value, d-axis voltage, q-axis voltage, d-axis current and electric angular velocity.

Yet further, according to the electric power steering apparatus as set forth in a fifth aspect of the invention, the electric power steering apparatus as set forth in any one of the first to fourth aspect of the present invention, further including:

electric angle information calculating means which detects a motor rotation angle to calculate an electric angle and an electric angular velocity,

wherein the abnormal time motor command value calculating means includes:
electromotive force calculating means which calculates an electromotive force while referring to a two-phase driving memory table expressing a relationship between an electromotive force and an electric angle obtained from the composite value of the electromotive force waveforms of the two normal phase coils; and,
phase current command value calculating means which calculates the phase current command values of the two phases according to the steering assisting current command value, electric angular velocity and the electromotive force.

### EFFECTS OF THE INVENTION

According to the invention, there can be provided the following effects: that is, even when a conduction abnormality occurs in one of drive systems for the phases of the star connected coils of a 3-phase brushless motor, a steering assisting torque smaller than in the normal time of the motor can be output continuously to thereby be able to reduce the load of a driver; and also, a variation in the torque at the then time can positively inform the driver of the occurrence of the abnormality.

### BRIEF DESCRIPTION OF THE DRAWINGS

FIG. 1 is a system structure view of a first embodiment of an electric power steering apparatus according to the invention.

FIG. 2 is a block diagram of a specific structure of a steering assisting control unit;

FIG. 3 is a block diagram of a specific structure of a control operation unit 23 shown in FIG. 2;

FIG. 4 is a characteristic diagram of a steering assisting current command value calculating map expressing the relationship between a steering torque and a steering assisting current command value;

FIG. 5 is a block diagram of a specific structure of a d-axis current command value calculating portion of a vector phase command value calculating circuit;

FIG. 6 is a characteristic diagram of a d-q-axis voltage calculating memory table;

FIG. 7 is a characteristic diagram of an electromotive force waveform generated in a 3-phase brushless motor when normal;

FIG. 8 is an explanatory view of a stator magnetic field model in the 3-phase brushless motor when two phases are in conduction;

FIG. 9 is a characteristic diagram of an electromotive force waveform in the 3-phase brushless motor when two phases are in conduction;

FIG. 10 is a characteristic diagram of the relationship between a motor and a motor torque in the 3-phase brushless motor when two phases are in conduction;

FIG. 11 is a characteristic diagram of the results obtained when phase current command values shown in FIG. 10 are converted to d-axis current command values and q-axis current command values;

FIG. 12 is an explanatory view of a motor operation model when two phases are driven according to the first embodiment of the invention;

FIG. 13 is a characteristic diagram of the relationship between a motor current and a motor torque when a motor current, which flows in the 3-phase brushless motor while the two phases are in conduction, is set constant and only the conducting direction thereof is changed;

FIG. 14 is an explanatory view of a motion model of an electric power steering apparatus;

FIG. 15 is a block diagram of a steering assisting control unit according to a second embodiment of the invention;

FIG. 16 is a characteristic diagram of a phase current command value calculating memory table according to the second embodiment;

FIG. 17 is a characteristic diagram of a memory table for checking, according to a motor angular velocity and a steering assisting current command value, whether a d-axis direct current command value is present or not; and

FIG. 18 is a characteristic diagram of a memory table for calculating a d-axis direct current command value according to a steering assisting current command value.

Description of Reference Numerals and Signs

| | |
|---|---|
| 1 | Steering wheel |
| 2 | Steering shaft |
| 3 | Steering torque sensor |
| 8 | Steering gear |
| 10 | Steering assisting mechanism |
| 12 | 3-phase brushless motor |
| 13 | Rotor rotation angle detect circuit |
| 20 | Steering assisting control unit |
| 21 | Vehicle speed sensor |
| 22 | Motor current detect circuit |
| 23 | Control operation unit |
| 24 | Motor drive circuit |
| 25 | FET gate drive circuit |
| 26 | Cutoff relay circuit |
| 27 | Abnormality detect circuit |
| 31 | Steering assisting current command value operating portion |
| 32 | Angle information operating portion |
| 32a | Electric angle converting portion |
| 32b | Differential circuit |
| 33 | Normal time motor command value calculating portion |
| 33a | d-axis current command value calculating portion |
| 33b | d-q-axis voltage calculating portion |
| 33c | q-axis current command value calculating portion |
| 33e | 2-phase/3-phase converting portion |
| 34 | Abnormal time motor command value calculating portion |
| 35 | Command value select portion |
| 36 | Motor current control portion |
| 61 | Electromotive force calculating portion |
| 62 | Phase current command value calculating portion |
| 63 | Current limit portion |
| 64 | Phase current command value calculating portion |
| 71u~71w | Select switch |
| 72 | Select control portion |
| 81u~81w | Subtractor |
| 82 | PI control portion |

### BEST MODE FOR CARRYING OUT THE INVENTION

Now, description will be given below of embodiments according to the invention with reference to the accompanying drawings.

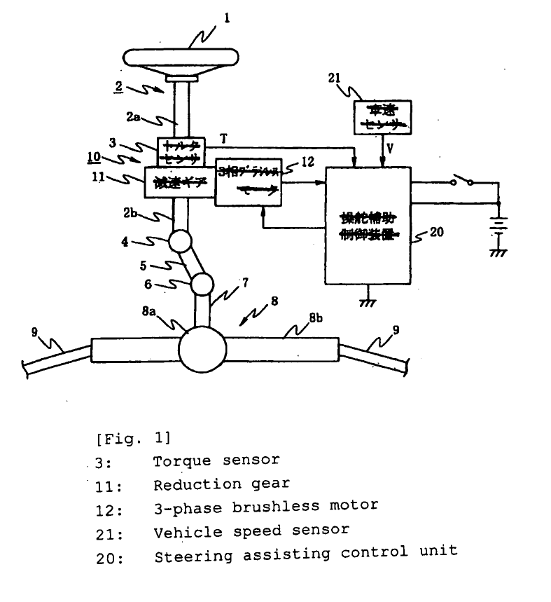

FIG. 1 is a structure view of the whole of a first embodiment according to the invention. In FIG. 1, reference numeral 1 designates a steering wheel; and, a steering force applied to the steering wheel 1 from a driver is transmitted to a steering shaft 2 including an input shaft 2a and an output shaft 2b. Referring to the structure of the steering shaft 2, one end of the input shaft 2a is connected to the steering wheel 1, while the other end thereof is connected to one end of the output shaft 2b through a steering torque sensor 3 serving as steering torque detect means.

The steering force transmitted to the output shaft 2b is then transmitted through a universal joint 4 to a lower shaft 5 and is further transmitted through a universal joint 6 to a pinion shaft 7. The steering force transmitted to the pinion shaft 7 is transmitted through a steering gear 8 to two tie rods 9, thereby operating road wheels (not shown). Here, the steering gear 8 has a rack and pinion type structure which includes a pinion 8a connected to the pinion shaft 7 and a rack 8b meshingly engaged with the pinion 8a; and, the rotation motion transmitted to the pinion 8a is converted into the linear motion in the direction of the width of the vehicle by the rack 8b.

To the output shaft 2b of the steering shaft 2, there is connected a steering assisting mechanism 10 which is used to transmit the steering assisting force to the output shaft 2b. The steering assisting mechanism 10 includes a reduction gear 11 connected to the output shaft 2b and a 3-phase brushless motor 12 which is connected to the reduction gear 11 and is used to generate the steering assisting force.

The steering torque sensor 3 is used to detect a steering torque which is applied to the steering wheel 1 and is then transmitted to the input shaft 2a. For example, the steering torque sensor 3 is structured such that it converts the steering torque to the torsion angle displacement of a torsion bar (not shown) interposed between the input shaft 2a and output shaft 2b and then converts the torsion angle displacement to a resistance variation or a magnetic variation, whereby it detects the steering torque in the form of such resistance variation and magnetic variation.

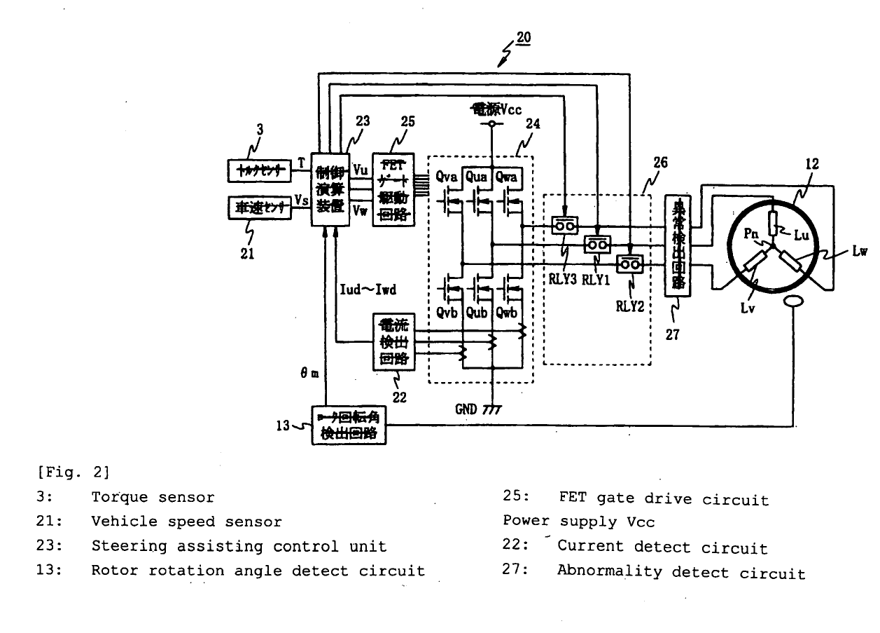

Also, referring to the structure of the 3-phase brushless motor 12, as shown in FIG. 2, the respective one-side ends of a U phase coil Lu, a V phase coil Lv and a W phase coil Lw are connected to each other to provide a star connection, while the other-side ends of the respective coils Lu, Lv and Lw are connected to a steering assisting control unit 20, whereby motor drive currents Lu, Iv and Iw are supplied from the unit 20 to the coils Lu, Lv and Lw individually. Also, the 3-phase brushless motor 12 includes a Hall element for detecting the rotation position of a rotor and a rotor rotation angle detect circuit 13 composed of a resolver or the like.

To the steering assisting control unit 20, there are input:

a steering torque T detected by the steering torque sensor 3;

a vehicle speed Vs detected by a vehicle speed sensor 21;

a rotor rotation angle θm detected by the rotor rotation angle detect circuit 13; and,

motor drive current detect values Iud, Ivd and Iwd respectively output from a motor current detect circuit 22 which is used to detect the motor drive currents Iu, Iv and Iw supplied to the respective phase coils Lu, Lv and Lw of the 3-phase brushless motor 12.

The steering assisting control unit 20 includes:

a control operation unit 23 which operates a steering assisting current target value according to the steering torque T, vehicle speed Vs, motor current detect values Iud, Ivd, Iwd and rotor rotation angle θm, and also outputs the respective phase motor voltage command values Vu, Vv and Vw;

a motor drive circuit 24 which is composed of field effect transistors (FET) and is used to drive the 3-phase brushless motor 12;

an FET gate drive circuit 25 for controlling the gate currents of the field effect transistors of the motor drive circuit 24 according to the phase motor voltage command values Vu, Vv and Vw respectively output from the control operation unit 23;

a cutoff relay circuit 26 serving as switching means connected between the motor drive circuit 24 and 3-phase brushless motor 12; and,

an abnormality detect circuit 27 for detecting an abnormality, if any, in the motor drive currents Iu, Iv and Iw supplied to the 3-phase brushless motor 12.

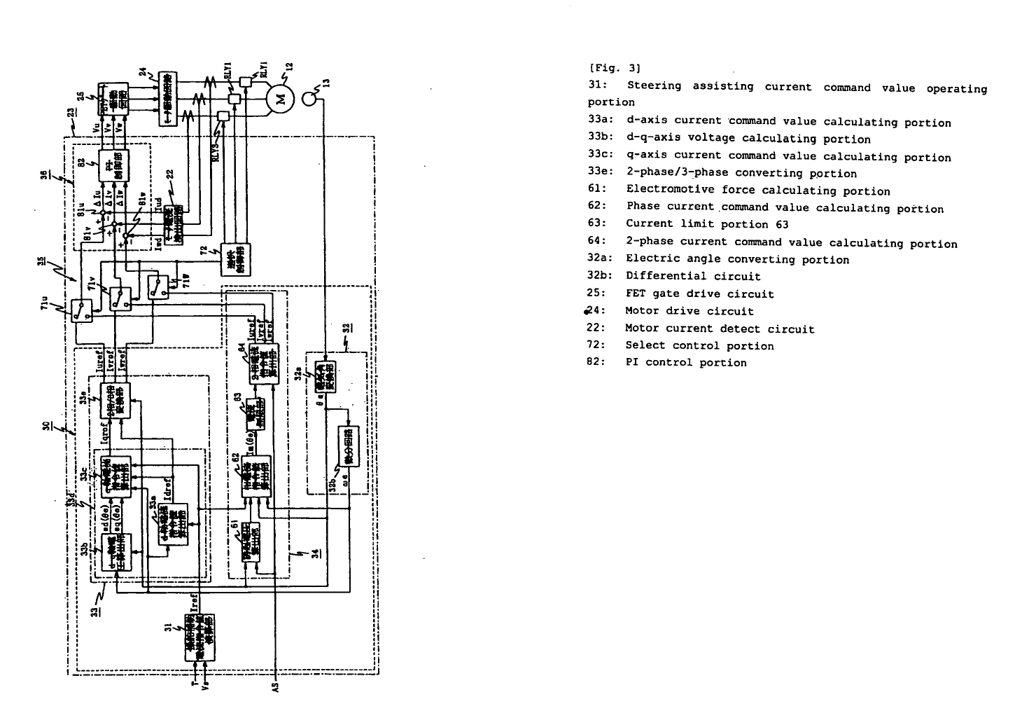

The control operation unit 23, as shown in FIG. 3, includes:

a steering assisting current command value operating portion 31 to which the steering torque T detected by the steering torque sensor 3 and the vehicle speed Vs detected by the vehicle speed sensor 21 are input, and also which calculates a steering assisting current command value Iref according to the thus input values;

an angle information operating portion 32 for calculating an electric angle θe and an electric angular velocity ωe according to the rotor rotation angle θm detected by the rotor rotation angle detect circuit 13;

a normal time motor command value calculating portion 33 for calculating three phase current command values Iuref˜Iwref according to the steering assisting command value Iref, electric angle θe and electric angular velocity ωe;

an abnormal time motor command value calculating portion 34 for calculating two phase current command values Iiref and Ijref for normal coils Li (i=u˜w) and Lj (j=v˜u) according to an abnormality detect signal AS input therein from an abnormality detect circuit 27 (which will be discussed later), steering assisting current command value Iref, electric angle θe and electric angular velocity ωe;

an command value select portion 35 for selecting the three phase current command values Luref˜Iwref respectively output from the normal time motor command value calculating portion 33 and the abnormal time motor command value calculating portion 34 or the two phase current command values Iiref and Ijref respectively output from the abnormal time motor command value calculating portion 34; and

a motor current control portion 36 for executing a current feedback processing using a current command value selected by the command value select portion 35 and motor current detect values Iud, Ivd and Iwd respectively detected by the motor current detect circuit 22.

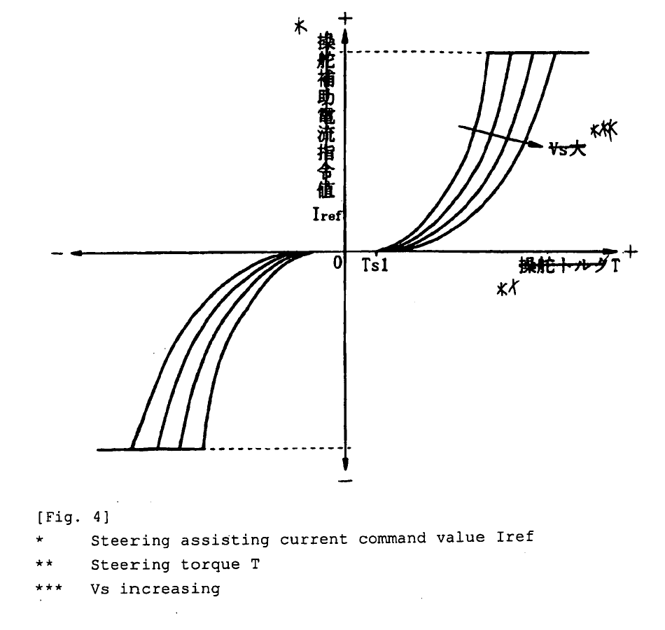

The steering assisting current command value operating portion 31 calculates the steering assisting current command value Iref according to the steering torque T and vehicle speed Vs with reference to a steering assisting current command value calculating map shown in FIG. 4. Here, the steering assisting current command value calculating map, as shown in FIG. 4, is structured as a characteristic diagram of parabolic curves in which the steering torque T is expressed on the horizontal axis, the steering assisting command value Iref is expressed on the vertical axis, and the vehicle speed detect value Vs is used as a parameter. Specifically, while the steering torque T exists from “0” to its neighboring set value Ts1, the steering assisting command value Iref maintains “0”. When the steering torque T exceeds the set value Ts1, at first, the steering assisting command value Iref increases relatively gently with respect to an increase in the steering torque T; when the steering torque T increases further, the steering assisting command value Iref increases steeply with respect to an increase in the steering torque T; and, the inclination of the characteristic curve decreases as the vehicle speed Vs increases.

Further, the angle information operating portion 32 includes:

an electric angle converting portion 32a for converting the rotor rotation angle θm detected by the rotor rotation angle detect circuit 13 to the electric angle θe, and

a differential circuit 32b for differentiating the electric angle θe output from the electric angle converting portion 32a to calculate the electric angular velocity ωe.

The normal time motor command value calculating portion 33, as shown in FIG. 3, has mainly a d-q-axis current command value calculating portion 33d and a 2-phase/3-phase converting portion 33e. Specifically, the d-q-axis current command value calculating portion 33d includes:

a d-axis current command value calculating portion 33a for calculating a d-axis current command value Idref according to the steering assisting current command value Iref and electric angular velocity ωe;

a d-q-axis voltage calculating portion 33b for calculating a d-axis voltage ed(θe) and a q-axis voltage eq(θe) according to the electric angle θe; and,

a q-axis current command value calculating portion 33c for calculating a q-axis current command value Iqref according to the d-axis voltage ed(θe) and q-axis voltage eq(θe) respectively output from the d-q-axis voltage calculating portion 33b, the d-axis current command value Idref output from the d-axis current command value calculating portion 33a, and the steering assisting current command value Iref output from the steering assisting current command value operating portion 31.

Also, the 2-phase/3-phase converting portion 33e is used to convert the d-axis current command value Idref output from the d-axis current command value calculating portion 33a and the q-axis current command value Iqref output from the q-axis current command value calculating portion 33c to the three phase current command values Iuref, Ivref and Iwref.

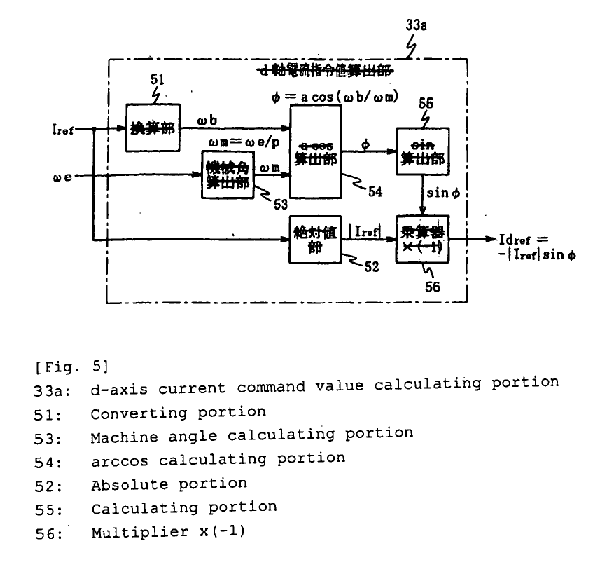

Also, the d-axis current command value calculating portion 33a, as shown in FIG. 5, includes:

a converting portion 51 for converting the steering assisting current command value Iref output from the steering assisting current command value operating portion 31 to a base angular velocity ωb which is to be supplied to the 3-phase brushless motor 12;

an absolute value portion 52 for calculating the absolute value |Iref| of the steering assisting current command value Iref;

a machine angle calculating portion 53 for calculating the machine angular velocity ωm(=ωe/P) of the motor according to the electric angular velocity ωe and the number of polarities P of the motor;

an a cos calculating portion 54 for calculating an advancing angle Φ=a cos(ωb/ωm) according to the base angular velocity ωb and machine angular velocity ωm;

a sin calculating portion 55 for calculating sin Φ according to the advancing angle Φ; and

a multiplier 56 for multiplying the absolute value |Iref| from the absolute value portion 52 and the sin Φ output from the sin calculating portion 55 together and then for −1 timing the products of the absolute value |Iref| and sin Φ to thereby calculate a d-axis current command value Idref(=−|Iref| sin Φ).

Since the d-axis current command value calculating portion 33a is structured in this manner, the d-axis current command value Idref can be expressed by the following equation (1):

Idref=−|Iref|·sin(a cos(ωb/ωm)) (1)

With respect to the term “a cos(ωb/ωm)” of the equation (1), when the rotation speed of the motor is not high, that is, when the machine angular velocity ωm of the 3-phase brushless motor 12 is lower than the base angular velocity ωb, there is obtained the relationship “ωm<ωb”, which results in “a cos(ωb/ωm)=0”; and, therefore, Idref=0.

However, when the motor rotation speed is high, that is, when the machine angular velocity ωm gets higher than the base angular velocity ωb, there appears the current command value Idref, whereby a field-weakening control is started. As expressed by the above equation (1), since the current command value Idref varies according to the rotation speed of the 3-phase brushless motor 12, there can be provided an excellent effect that the control in the high speed rotation time can be carried out smoothly with no interruption.

There can also be provided another effect in the saturation of the motor terminal voltage. The phase voltage V of a motor is generally expressed by the following equation (2), that is,

V=E+R·I+L(di/dt) (2),

where E expresses a back electromotive force, R fixed resistance and L an inductance, respectively. Since the back electromotive force E increases as the rotation speed of the motor increases and a power supply voltage such as a battery voltage is fixed, the range of the voltage usable for the control of the motor is narrowed accordingly. Suppose the angular velocity, where the voltage reaches saturation, is the base angular velocity ωb, when there occurs the voltage saturation, the duty ratio of the PWM control reaches 100% and thus the PWM control becomes unable to follow the current command value any further, resulting in the increased torque ripple.

However, the polarity of the current command value Idref expressed by the above equation (1) is negative, and the polarity of the electromotive force component of the current command value Idref relating to the term “L(di/dt)” of the equation (2) is opposite to the polarity of the back electromotive force E. This shows the effect that the back electromotive force E, which gets larger as the motor rotation speed increases, can be reduced by the voltage induced due to the current command value Idref. As a result of this, even when the rotation speed of the 3-phase brushless motor 12 becomes high, the effect of the current command value Idref can widen the voltage range that can control the motor. That is, the field-weakening control provided by the control of the current command value Idref can prevent the control voltage of the motor from being saturated, whereby the controllable voltage range can be widened, and thus, even in the high speed rotation time of the motor, the torque ripple can be prevented from increasing.

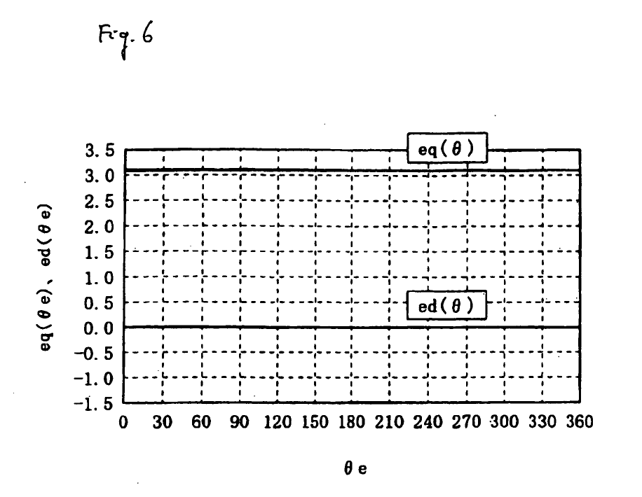

Further, the d-q-axis voltage calculating portion 33b calculates a d-axis voltage ed(θe) and a q-axis voltage eq(θe) according to the electric angle θe with reference to a d-q-axis voltage calculating memory table shown in FIG. 6 serving as a 3-phase driving memory table. Here, the d-q-axis voltage calculating memory table, as shown in FIG. 6, is structured such that the electric angle θe is expressed on the horizontal axis, while the d-axis voltage ed(θ) and q-axis voltage eq(θ), which are obtained by converting electromotive force waveforms generated from the respective phase coils to rotation coordinates, are respectively expressed on the vertical axis. When the 3-phase brushless motor 12 is a sine wave electromotive force motor in which, as shown in FIG. 7, its electromotive force waveforms, that is, a U phase EMF, a V phase EMF and a W phase EMF provide sine waveforms different by 120 degrees in phase from each other, as shown in FIG. 7, the d-axis voltage ed(θ) and q-axis voltage eq(θ) both provide constant values regardless of the electric angle θ.

Still further, the q-axis current command value calculating portion 33c carries out the below-mentioned equation (3) according to the steering assisting current command value Iref, d-axis voltage ed(θe), q-axis voltage eq(θe), d-axis current command value Idref and electric angular velocity ωe respectively input therein to thereby calculate a q-axis current command value Iqref.

Iqref={Kt×Iref×ωe−ed(θe)×Idref(θe)}/eq(θe) (3),

where Kt expresses a motor torque constant.

Further, the abnormal time motor command value calculating portion 34, when the drive system of any one of the three phases of the 3-phase brushless motor 12 becomes abnormal, is used to continue the rotation and driving of the 3-phase brushless motor 12 using the two remaining phase coils.

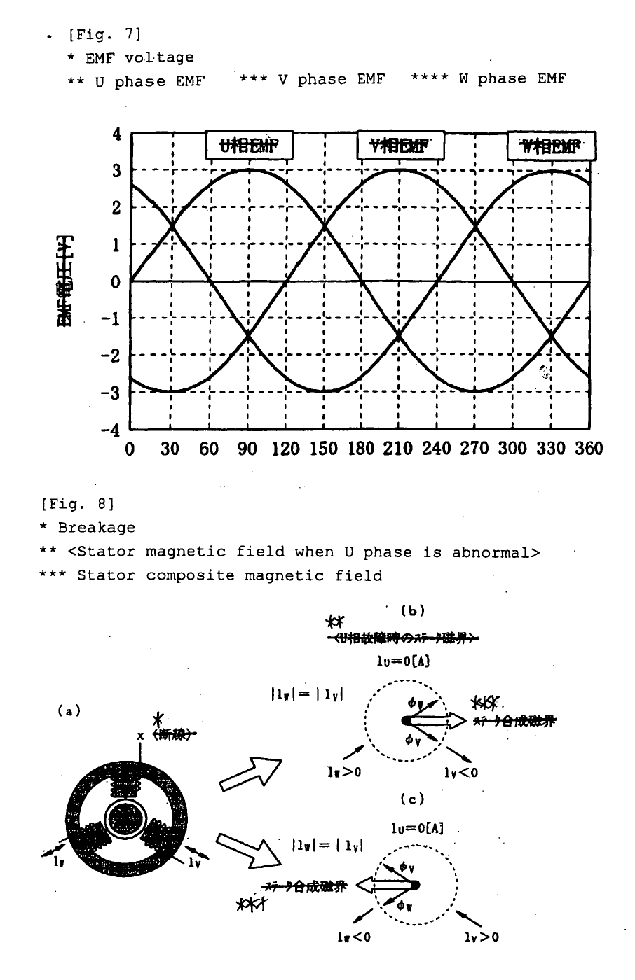

That is, assuming that, in the 3-phase brushless motor 12, for example, as shown in FIG. 8A, breakage occurs in the wire of a drive system for the U phase coil Lu to thereby be unable to supply the motor current to the U phase coil Lu, the coils that can supply the motor current provide two coils, specifically, the V phase coil Lv and W phase coil Lw. And, the directions of currents to be supplied to these V phase coil Lv and W phase coil Lw provide two directions: that is, one is a direction in which the motor current is input from the V phase coil Lv and is output from the W phase coil Lw; and, the other is a direction in which the motor current is input from the W phase coil Lw and is output from the V phase coil Lv.

Stator composite magnetic fields to be generated by these motor currents, as shown in FIGS. 8B and 8C, can be simply formed only in the two 180-degree different directions. Therefore, the 3-phase brushless motor 12 cannot be 2-phase driven only by these two stator composite magnetic fields.

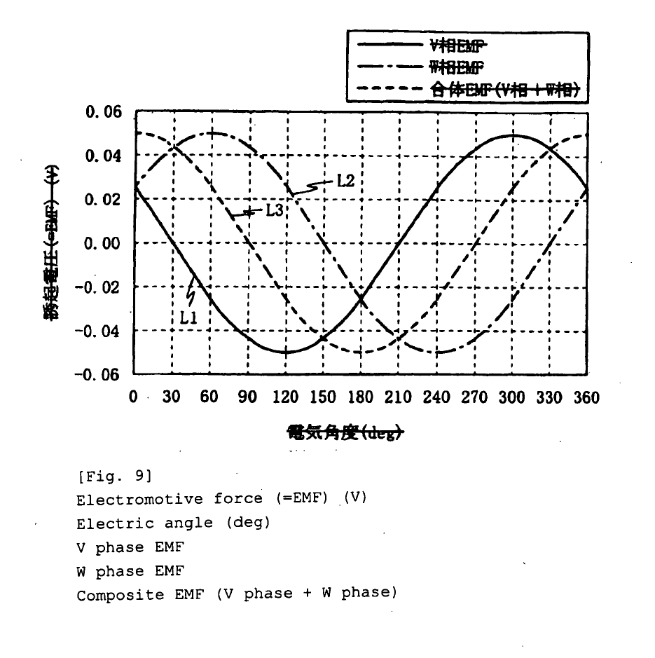

In view of this, according to the present embodiment, for example, suppose a conduction abnormality occurs in the U phase drive system, a motor electromotive force when driving the motor using the two remaining V and W phases, as shown in FIG. 9, is considered to provide a composite electromotive force EMFa expressed by a characteristic curve L3 which is compounded of two electromotive forces EMFv(θe) and EMFw(θe) respectively shown by characteristic curves L1 and L2 with respect to the electric angle θe. And, according to the composite electromotive force EMFa, there is calculated a motor current Im(θe).

That is, the abnormal time motor command value calculating portion 34, as shown in FIG. 3, has:

an electromotive force calculating portion 61 for calculating a composite electromotive force EMFa(θe) according to the electric angle θe and an abnormality detect signal AS output from an abnormality detect circuit 27 (which will be discussed later);

a phase current command value calculating portion 62 for calculating a phase current command value Im(θe) according to the composite electromotive force EMFa(θe) calculated by the electromotive force calculating portion 61, steering assisting current command value Iref and electric angular velocity ωe;

a current limit portion 63 for limiting the phase current command value Im(θe) calculated by the phase current command value calculating portion 62 using the maximum current value Imax that can be output by the motor drive circuit 24; and,

a 2-phase current command value calculating portion 64 for outputting the current command values of the corresponding two phases according to the phase current command value limited by the current limit portion 63.

Here, the electromotive force calculating portion 61 includes three composite electromotive force calculating memory tables each serving as a 2-phase driving memory table. The 2-phase driving memory table includes:

a composite electromotive force calculating memory table for showing the relationship between the composite electromotive force EMFa expressed and electric angle θe shown by the characteristic curve L3 in FIG. 9 when driving the motor using the two V and W phases;

a composite electromotive force calculating memory table for showing the relationship between the composite electromotive force EMFa and electric angle θe when driving the motor using the two U and V phases; and,

a composite electromotive force calculating memory table for showing the relationship between the composite electromotive force EMFa and electric angle θe when driving the motor using the two U and W phases.

In operation, the electromotive force calculating portion 61, according to the abnormality detect signal AS, selects the composite electromotive force calculating memory table that corresponds to the two normal phases, and calculates the composite electromotive force EMFa(θe) with reference to the composite electromotive force calculating memory table that is selected according to the electric angle θe.

Also, the phase current command value calculating portion 62 carries out the following equation (4) according to the composite electromotive force EMFa output from the electromotive force calculating portion 61, steering assisting current command value Iref calculated by the steering assisting current command value operating portion 31, and electric angle θe, thereby calculating a phase current command value Im(θe).

Im(θe)=(Kt2×Iref×ωe)/EMFa(θe) (4),

where Kt2 expresses a motor torque constant when the two phases are in conduction.

Further, the 2-phase current command value calculating portion 64, according to the abnormality detect signal output from the abnormality detect circuit 27, decides the two phases that are to be put into conduction; and also, it sets the conduction direction of the phase current command value Im(θe) according to the sign of the phase current command value Im(θe) calculated by the phase current command value calculating portion 62, and outputs the current command value Ikref(k=u˜w) of one phase corresponding to the thus set conduction direction to the subtractor 81k of the motor current control portion 36.

Further, the command value select portion 35 includes:

change-over switches 71u, 71v and 71w structured such that, to the normally closed contacts thereof, there are input phase current command values Iuref, Ivref and Iwref respectively calculated by the 2-phase/3-phase converting portion 33e of the normal time motor command value calculating portion 33, while, to the normally open contacts thereof, there are input motor current command values Iuref, Ivref and Iwref respectively output from the abnormal time motor command value calculating portion 34; and,

a select control portion 72 for switching and controlling these change-over switches 71u, 71v and 71w.

Here, the select control portion 72, when the abnormality detect signal AS output from the abnormality detect circuit 27 is “0“, outputs a select signal SS of a logical value “0” to the change-over switches 71u˜71w for selecting the normally closed contacts thereof and also outputs relay control signals RS1˜RS3 to cutoff relay circuits RLY1˜RLY3 (which will be discussed later) for controlling them to turn on. And, when the abnormality detect signal AS is “1”˜“3”, the select control portion 72 outputs a select signal SS of a logical value “1” to the change-over switches 71u˜71w for selecting the normally open contacts thereof and also outputs a relay control signal RSx to a cutoff relay circuit RLYx (x=u˜w) corresponding to an abnormal drive system for turning it off.

The motor current control portion 36 includes:

subtractors 81u, 81v and 81w for subtracting motor phase current detect values Iud, Ivd and Iwd of currents respectively flowing in the phase coils Lu, Lv and Lw and detected by the current detect circuit 22 respectively from the current command values Iuref, Ivref and Iwref supplied from the command value select portion 35, thereby obtaining phase current deviations ΔIu, ΔIv and ΔIw respectively; and

a PI control portion 82 for carrying out a proportional integration control on the thus obtained respective phase current deviations ΔIu, ΔIv and ΔIw to calculate instruction voltages Vu, Vv and Vw respectively.

And, the instruction voltages Vu, Vv and Vw output from the PI control portion 82 are then supplied to the FET gate drive circuit 25.

The motor drive circuit 24, as shown in FIG. 2, has an inverter structure in which switching elements Qua, Qub, Qva, Qvb, Qwa and Qwb respectively composed of N-channel MOSFETs connected in series correspondingly to the phase coils Lu, Lv and Lw are connected in parallel. In this structure, the connecting points of the switching elements Qua and Qub, the connecting points of the switching elements Qva and Qvb, and the connecting points of the switching elements Qwa and Qwb are respectively connected to the opposite side of the neutral point Pn of the respective phase coils Lu, Lv and Lw.

And, to the gates of the respective switching elements Qua, Qub, Qva, Qvb, Qwa and Qwb which cooperate together in constituting the motor drive circuit 24, there are supplied a PWM (pulse width modulation) signal which is output from the FET gate drive circuit 25.

Further, the cutoff relay circuit 26 includes:

the relay contacts RLY1, RLY2 and RLY3 individually interposed between the opposite side terminals of the phase coils Lu, Lv and Lw of the 3-phase brushless motor 12 to the neutral point Pn and

the connecting points of the field effect transistors Qua, Qub, Qva, Qvb, Qwa and Qwb.

In a normal state where no abnormality is detected in any of the phases by the abnormality detect circuit 27, the relay contacts RLY1˜RLY3 are respectively controlled to the closed states thereof; and, when any one of the phases is detected abnormal, the relay contact RYLi (i=1˜3) of the abnormal phase is controlled to be open.

Also, the abnormality detect circuit 27 compares the voltage command values Vu, Vv and Vw to be supplied to the FET gate drive circuit 25 or a pulse width modulation signal to be supplied to the motor drive circuit 24 with the motor voltages of the respective phases, thereby being able to detect the non-conduction and short abnormality of the U phase, V phase and W phase. And, the abnormality detect circuit 27 outputs a phase abnormality detect signal AS to the abnormal time motor command value calculating portion 34 and command value select portion 35 of the control operation unit 23. Here, the phase abnormality detect signal AS is “0” when the U, V and W phases are all normal, “U1” when the U phase is in a non-conduction abnormal state, “U2” when the U phase is in a short abnormal state, “V1” when the V phase is in a non-conduction abnormal state, “V2” when the V phase is in a short abnormal state, “W1” when the W phase is in a non-conduction abnormal state, and “W2” when the W phase is in a short abnormal state.

Next, description will be given below of the operation of the above-mentioned first embodiment.

In a normal state where the field effect transistors Qua˜Qwb respectively constituting the motor drive circuit 24 are normal and the respective coils Lu Lw of the 3-phase brushless motor 12 are neither broken nor grounded, the abnormality detect circuit 27 does not detect an abnormal state but an abnormality detect signal expressing “0” is output to the abnormal time motor command value calculating portion 34 and command value select portion 35.

Accordingly, the select control portion 72 of the command value select portion 35 outputs a select signal SS of a logical value “0” to the change-over switches 71u˜71w, whereby the change-over switches 71u˜71w respectively select the phase current command values of the normally closed contacts sides thereof, that is, the phase current command values Iuref Iwref output from the normal time motor command value calculating portion 33, and outputs them to the motor current control portion 36. At the same time, to the respective relay contacts RLY1˜RLY3, there is output a relay control signal RS which controls and switches these relay contacts to close them.

In response to this, the motor drive currents Iu, Iv and Iw output from the motor drive circuit 24 are supplied through the relay contacts RLY1, RLY2 and RLY3 to the phase coils Lu, Lv and Lw of the 3-phase brushless motor 12 respectively.

In this case, for example, while the vehicle is stopping, in a state where the steering wheel 1 is not being steered, a steering torque T detected by the steering torque sensor 3 is “0”. Thus, the steering assisting current command value Iref calculated by the steering assisting current command value operating portion 31 of the control operation unit 23 provides “0”, and the electric angular velocity ωe output from the differential circuit 32b of the angle information operating portion 32 also provides “0”. Accordingly, the d-axis current command value Idref calculated by the d-axis current command value calculating portion 33a also provides “0”, and the q-axis current command value Iqref calculated by the d-axis current command value calculating portion 33c according the equation (3) also provides “0”, whereby the phase current command values Iuref, Ivref and Iwref output from the 2-phase/3-phase converting portion 33e also provide “0” respectively.

At the then time, since the 3-phase brushless motor 12 is also stopping, the motor current detect values Iud, Ivd and Iwd detected by the motor current detect circuit 22 are “0” respectively. Accordingly, the current deviations ΔIu, ΔIv and ΔIw output from the subtractors 81u, 81v and 81w of the motor current control portion 36 are also “0” respectively, and the voltage command values Vu, Vv and Vw output from the PI control portion 82 are also “0” respectively. Thus, the duty ratio of a pulse width modulation signal output from the FET gate drive circuit 25 to the gates of the field effect transistors Qua, Qub, Qva, Qvb, Qwa and Qwb of the motor drive circuit 24 is controlled down to 50%, and also there is set a dead time in the pulse width modulation signal supplied to the field effect transistors of the upper arm and in the pulse width modulation signal supplied to the field effect transistors of the lower arm, thereby preventing the field effect transistors Qua, Qva and Qwa of the upper arm and the field effect transistors Qub, Qvb and Qwb of the lower arm from conducting with each other. Therefore, the motor currents Iu, Iv and Iw supplied to the phase coils Lu, Lv and Lw of the 3-phase brushless motor 12 provide “0” respectively, whereby the 3-phase brushless motor 12 can maintain the stopping state thereof.

While the vehicle is stopping, when the steering wheel 1 is steered from a non-steered state to a state in which the steering wheel 1 is steered while the vehicle is stopped, the value of the steering torque T detected by the steering torque sensor 3 increases accordingly. Also, since the vehicle speed Vs is “0”, in the steering assisting current command value calculating map shown in FIG. 4, there is selected the steepest characteristic curve, whereby there is calculated such a large steering assisting current command value Iref as corresponds to the increased steering torque T. This increases the d-axis current command value Idref that is calculated by the d-axis current command value calculating portion 33a.

At the then time, since the 3-phase brushless motor 12 is stopping, the electric angle ωe continues the state of “0”. However, in the d-q-axis voltage calculating memory table shown in FIG. 6, the d-axis voltage ed(θ) is maintained at “0” and the q-axis voltage eq(θ) is maintained at, for example, 3.0 regardless of the electric angle ωe, which is supplied to the q-axis current command value calculating portion 33c. Accordingly, the q-axis current command value calculating portion 33c carries out the operation of the equation (3) to calculate a q-axis current command value Iqref.

And, the 2-phase/3-phase converting portion 33e carries out a three phase converting processing on the thus calculated d-axis current command value Idref and q-axis current command value Iqref to calculate the respective phase current command values Iuref, Ivref and Iwref, which are supplied to the motor current control portion 36.

Therefore, in the motor current control portion 36, since the motor current detect values Iud, Ivd and Iwd input therein from the motor current detect circuit 22 maintain “0” respectively, the current deviations ΔIu, ΔIv and ΔIw output from the subtractors 81u, 81v and 81w are varied from “0”; and, the PI control portion 82 carries out a PI control processing on the current deviations ΔIu, ΔIv and ΔIw to calculate the instruction voltages Vu, Vv and Vw, and the thus calculated instruction voltages Vu, Vv and Vw are then supplied to the FET gate drive circuit 25. Owing to this, the field effect transistors of the motor drive circuit 24 are controlled respectively, while the motor phase currents Iu, Iv and Iw, which are 120 degrees out of phase from each other, are output from the motor drive circuit 24 to the phase coils Lu, Lv and Lw of the 3-phase brushless motor 12. As a result of this, the 3-phase brushless motor 12 is driven and rotated to generate a steering assisting force corresponding to a steering torque to be input to the steering wheel 1, and the steering assisting force is transmitted through the reduction gear 11 to the steering shaft 2, thereby being able to steer the steering wheel 1 with a light steering force.

After then, when the vehicle starts to run, since the steering assisting current command value Iref calculated by the steering assisting current command value operating portion 31 decreases accordingly, the d-axis current command value Idref and q-axis current command value Iqref decrease, while the motor current command values Iuref, Ivref and Iwref output from the 2-phase/3-phase converting portion 33e decrease. In response to this, the motor drive currents Iu, Iv and Iw decrease, thereby decreasing the steering assisting force that is generated by the 3-phase brushless motor 12.

And, when the motor drive circuit 24 is switched from this normal state to a drive mode for driving, for example, the phase coil Lu, that is, a mode where the field effect transistor Qua or Qub of the motor drive circuit 24 continues its off state, or when there is generated any breakage in a conducting path including the U phase coil Lu, thereby causing an abnormality that the U phase coil Lu is non-conducting, such abnormality is detected by the abnormality detect circuit 27. Thus, the abnormality detect circuit 27 supplies a “U1” phase abnormality detect signal AS expressing a non-conduction abnormality to the abnormal time motor command value calculating portion 34 and command value select portion 35.

Accordingly, when the command value select portion 35 inputs therein an abnormality detect signal AS of a logical value “1”, the command value select portion 35 outputs a select signal SS of a logical value “1” to the select switches 71u˜71w and also outputs a relay control signal RS1 to the cutoff relay circuit RLY1, while the relay control signal RS1 is used to switch the cutoff relay RLY1 to the off state thereof.

In response to this, the change-over switches 71u˜71w are respectively switched from the normally closed contacts sides to the normally open contacts sides; and thus, the phase current command values Iuref˜Iwref respectively output from the normal time motor command value calculating portion 33 are switched over to the phase current command values Iuref˜Iwref respectively output from the abnormal time motor command value calculating portion 34.

On the other hand, in the abnormal time motor command value calculating portion 34, since the abnormality detect signal AS input therein from the abnormality detect circuit 27 is “U1” which expresses the U phase non-conduction abnormality, the electromotive force calculating portion 61 selects an electromotive force calculating memory table showing a composite electromotive force compounded of a V phase electromotive force and a W phase electromotive force and also refers to this electromotive force calculating memory table according to an electric angle θe input from the angle information operating portion 32 to thereby calculate a composite electromotive force EMFa(θe) which is compounded of the V phase electromotive force and W phase electromotive force.

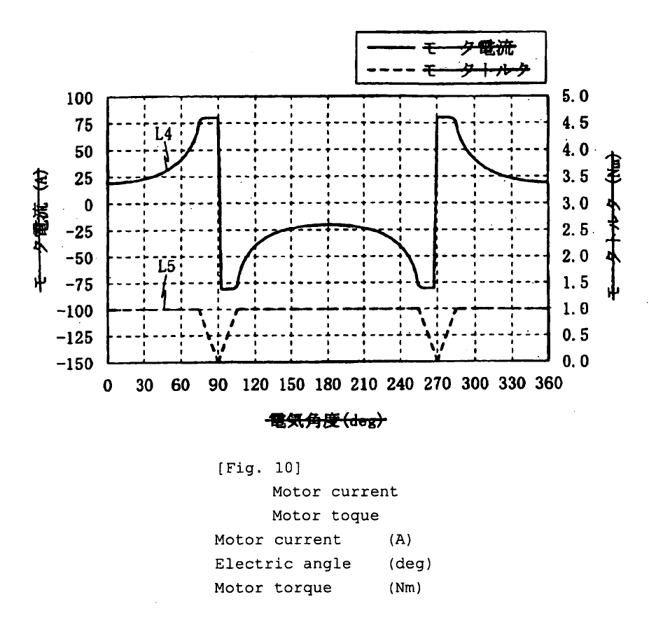

And, the thus calculated composite electromotive force EMFa(θe) is supplied to the phase current command value calculating portion 62. The phase current command value calculating portion 62 carries out the operation of the equation (4) to calculate a phase current command value Im(θe). The thus calculated phase current command value Im(θe), as shown in FIG. 10, provides a characteristic curve L4. Specifically,

while the electric angle θe increases from 0° up to 75°, the calculated phase current command value Im(θe) increases from +20 A up to +80 A like an arc which projects upwardly;

during the range of 75°˜90°, it maintains +80 A;

at 90°, it reverses down to −80 A;

after then, until 105°, it maintains −80 A;

after then, until 180°, it increases up to −20 A like an arc projecting upwardly;

after then, until 255°, it decreases like an arc projecting upwardly;

during 255°˜270°, it maintains −80 A;

at 270°, it reverses up to +80 A;

after then, until 285°, it maintains +80 A;

after then, it decreases like a curve projecting downwardly; and,

at 360°, it decreases down to +20 A.

And, the calculated phase current command value Im(θe) is supplied to the current limit portion 63 and, when the phase current command value Im(θe) exceeds the maximum current value Imax that can be output by the motor drive circuit 24, the current limit portion 63 limits the current command value Im(θe) to the maximum current value Imax.

Then, the phase current command value Im(θe) limited by the current limit portion 63 is supplied to the 2-phase current command value calculating portion 64. The 2-phase current command value calculating portion 64 selects the V phase current command value Ivref and W phase current command value Iwref according to the abnormality detect signal AS input therein from the abnormality detect circuit 27; and, at the same time, the 2-phase current command value calculating portion 64, according to the sign of the phase current command value Im(θe), sets from of which the V phase current command value Ivref and W phase current command value Iwref the current is allowed to flow, and selects the phase current command value Ivref or Iwref that corresponds to such setting.

In this case, the phase current command values Iuref˜Iwref are output to the select switches 71u˜71w in the following manner: that is,

when the electric angle θe is 0°˜90°, in order that the current is allowed to flow from the W phase coil Lw toward the V phase coil Lv, the W phase current command value Iwref is set as a positive value;

when the electric angle θe is 90°˜270°, in order that the current is allowed to flow from the V phase coil Lv toward the W phase coil Lw, the V phase current command value Ivref is set as a positive value;

when the electric angle θe is 270°˜360°, in order that the current is allowed to flow from the W phase coil Lw toward the V phase coil Lv, the W phase current command value Iwref is set as a positive value; and, the other remaining phase current command value Iuref is set as “0”.

Therefore, when the electric angle θe is 0°˜90°, to the 3-phase brushless motor 12, there is supplied the W phase motor current Iw and this current flows from the W phase coil Lw through the V phase coil Lv, whereby there is generated a rotating stator composite magnetic field to cause the rotor to rotate;

when the electric angle θe is 90°˜180°, there is supplied the V phase current Iv and this current flows from the V phase coil Lv through the W phase coil Lw, whereby there is generated a rotating stator composite magnetic field to cause the rotor to rotate further;

after then, when the electric angle θe is 180°˜270°, there is supplied the W phase current Iw and this current flows from the W phase coil Lw through the V phase coil Lv, whereby there is generated a rotating stator composite magnetic field to cause the rotor to rotate further;

when the electric angle θe is 270°˜360°, there is supplied the V phase current Iv and this current flows from the V phase coil Lv through the W phase coil Lw, whereby there is generated a rotating stator composite magnetic field to cause the rotor to rotate further; and,

by repeating these operations, the 3-phase brushless motor 12 can be two-phase driven.

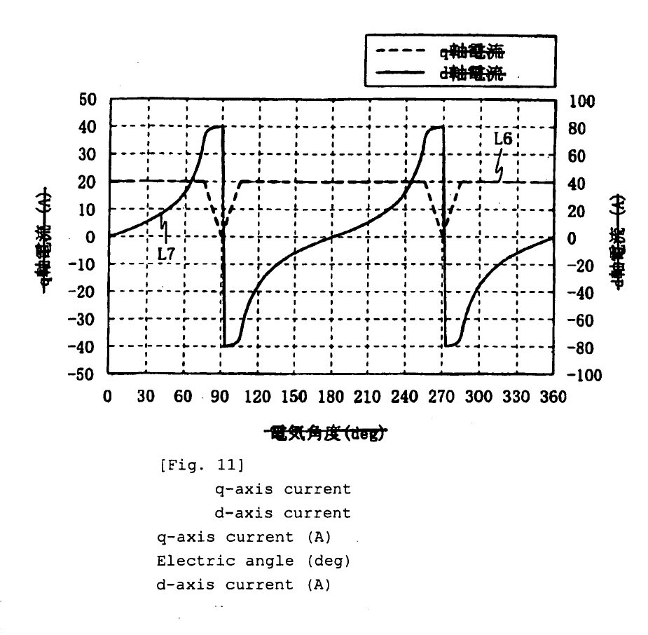

That is, when the phase current command value Im(θe) calculated according to the equation (4) and expressed by the characteristic curve L4 shown in FIG. 10 is converted to the d-q-axis coordinates to calculate the d-axis current command value Idref and q-axis current command value Iqref, these d-axis current command value Idref and q-axis current command value Iqref respectively show such characteristics as shown in FIG. 11. Specifically, the q-axis current command value Iqref, as shown by its characteristic curve L6, maintains +20 A except that it provides 0 A once when the electric angle θe is in the vicinity of 90° and 270°.

On the other hand, the d-axis current command value Idref has such a characteristic as shown by its characteristic curve L7. That is, it increases from +0 A to +40 A in an arc projecting downwardly while the electric angle θe increases from 0° to 75°;

it maintains +40 A during 75°˜90°;

it provides 0 A at 90° once and then reverses down to −40 A;

after then, it maintains −40 A until 105°;

after then, it increases up to 0 A in an arc projecting upwardly until 180°;

after then, it increases from 0 A up to +40 A in an arc projecting downwardly until 255°;

it maintains +40 A during 255°˜270°;

it provides 0 A once at 270° and then reverses down to −40 A;

after then, it maintains −40 A until 285°, then increases in a curve projecting upwardly, and provides 0 A at 360°.

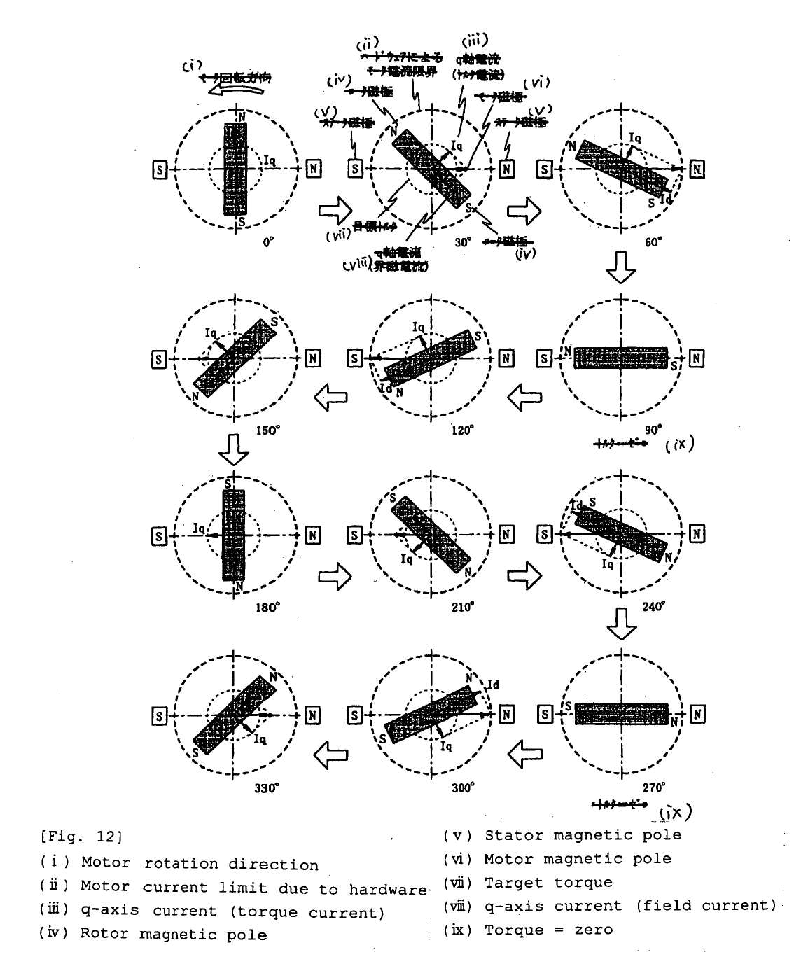

Therefore, when the 3-phase brushless motor 12 is 2-phase driven according to the d-axis current command value Idref and q-axis current command value Iqref, the motor operation model of the 3-phase brushless motor 12 is as shown in FIG. 12. Specifically, when the electric angle θe is 0°, there is output only the q-axis current command value Iqref expressing a torque current, whereby the magnetic pole of the rotor provides a state where it intersects with the magnetic pole of the stator. After then, when the electric angle θe becomes 30°, the q-axis current command value Iqref does not change but the d-axis current command value Idref expressing a field current increases in the positive direction, whereby the phase current command value Im(θe) expressed as the composite vectors of these d-axis current command value Idref and q-axis current command value Iqref provides a direction of 45° with respect to the rotor magnetic pole, while this direction is opposed to the N pole of the stator magnetic pole. After then, since the d-axis current command value Idref increases in the positive direction, the phase current command value Im(θe) provides a direction of 30° with respect to the rotor magnetic pole. Thus, the rotor magnetic pole is rotated according to these directions of the phase current command value Im(θe).

After then, as shown in FIG. 12, since, at the electric angle of 90°, the d-axis current command value Idref and q-axis current command value Iqref are both “0”, the steering assisting torque provides a “0” state; and, at the then time, since the rotor is attracted by the stator magnetic pole, the end portion of the rotor provides a state where it is opposed to the stator magnetic pole.

After then, since the d-axis current command value Idref takes a large value in the negative direction, the phase current command value Im(θe) provides an angle of 135° to the rotor magnetic pole to thereby rotate the rotor magnetic pole; and, after then, as the d-axis current command value Idref expressing the field current changes sequentially, the rotor magnetic pole continues to rotate.

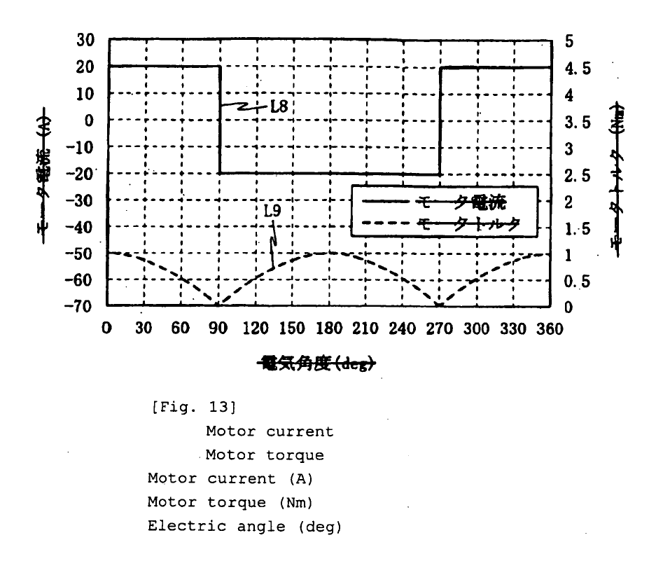

Here, as shown by a characteristic curve L8 in FIG. 13, when the current value of the motor current Im(θe) is not changed according to the electric angle θe but only the direction of the motor current is changed, a steering assisting torque generated in the 3-phase brushless motor 12, as shown by a characteristic curve L9 in FIG. 13, provides the maximum value 1 Nm at the electric angle of 0°;

after then, toward the electric angle of 90°, it decreases in an arc and, at the electric angle of 90°, it provides “0”;

after then, it increases from the electric angle of 90° toward the electric angle of 180° and reaches the maximum value 1 Nm at the electric angle of 90°; and,

after then, it decreases in an arc toward the electric angle of 270° and it provides “0” at the electric angle of 270°.

The steering assisting torque repeats this cycle.

Thus, when switching only the direction of the current of the motor current Im(θe), the torque variations become large, which gives a driver a strange feeling. However, according to the present embodiment, since there is obtained the current characteristic shown by the characteristic curve L4 in FIG. 10, the range where the steering assisting torque decreases is reduced, thereby being able to provide an effect that the motor rotational driving operation can easily deal with the area where the steering assisting torque decreases. Also, since the steering assisting torque, as shown by the characteristic curve L5 in FIG. 10, provides such a torque variation that the torque takes the value “0” once in the vicinity of the electric angles θe of 90° and 270°, it is possible to positively inform the driver that a conduction abnormality has occurred in the 3-phase brushless motor 12.

Also, when the abnormality of the U phase drive system detected by the abnormality detect circuit 27 is the short abnormality of the field effect transistor Qua or Qub of the motor drive circuit 24, the abnormality detect circuit 27 outputs an abnormality detect signal As expressing “U2”; and, when this signal As is supplied to the select control portion 72 of the command value select portion 35, the select control portion 72 supplies to the cutoff relay RLY1 of the U phase a relay control signal RS1 which puts the cutoff relay RLY1 into the cutoff state thereof. As a result of this, except that an electric power supply system to the U phase coil Lu of the 3-phase brushless motor 12 is cut off, there is carried out a similar processing to the above-mentioned non-conduction abnormality, so that the 3-phase brushless motor 12 is 2-phase conduction controlled to thereby continue the rotational driving of the motor 12.

Here, also when a non-conduction abnormality or a short abnormality occurs in the V phase or W phase drive system besides the U phase drive system, by controlling the conduction of the two normal phases similarly to the above-mentioned manner, the rotational driving of the motor can be continued.

In this manner, according to the above-mentioned first embodiment, when the drive systems for the respective phase coils Lu˜Lw of the 3-phase brushless motor 12 are all normal, as usual, the normal time motor command value calculating portion 33 calculates the d-axis current command value Idref according to a steering assisting current command value Iref and an electric angle ωe respectively corresponding to a steering torque T calculated by the steering assisting current command value operating portion 31; and also,

the d-q-axis current command value calculating portion 33d calculates a d-axis voltage ed(θe) and a q-axis voltage eq(θe) according to the electric angle θe with reference to the d-q-axis voltage calculating memory table shown in FIG. 6, thereby calculating a q-axis current Iqref according to the above-mentioned equation (3). And, the d-axis current command value Idref and q-axis current command value Iqref are respectively 2-phase/3-phase converted to calculate the respective phase current command values Iuref, Ivref and Iwref, and the 3-phase brushless motor 12 is feedback controlled according to these phase current command values Iuref, Ivref and Iwref as well as the motor currents Iud, Ivd and Iwd detected by the motor current detect circuit 22, whereby the 3-phase brushless motor 12 is allowed to generate the optimum steering assisting force corresponding to the steering torque T and vehicle speed Vs, thereby being able to carry out the optimum steering assisting control.

However, when breakage occurs in one of the drive systems for the respective phase coils Lu˜Lw of the 3-phase brushless motor 12 to thereby cause an abnormal state where the motor current Iy cannot be supplied to one of the phase coils Ly (y=u˜w), such abnormal state is detected by the abnormality detect circuit 27. As a result of this, the command value select portion 35 selects the abnormal time motor command value calculating portion 34. At the same time, the abnormal time motor command value calculating portion 34, while using the two normal phases, calculates a phase current command value for changing the direction of conduction, as shown in FIG. 10, in the range of an electric angle θe of 0°˜90°, in the range of 90°˜180°, in the range of 180°˜270° and in the range of 270°˜360°. And, by carrying out a feedback control on the 3-phase brushless motor 12 according to this phase current command value and the motor current detected by the motor current detect circuit 22, the driving of the 3-phase brushless motor 12 can be continued.

At the then time, the steering assisting torque generated in the 3-phase brushless motor 12, as shown by the characteristic line L5 in FIG. 10, generates a torque variation in which the torque provides 0 once in the vicinity of the electric angle θe of 90° and 270°, while this torque variation makes it possible to positively inform the driver that an abnormality has occurred in the 3-phase brushless motor 12.

Therefore, when an abnormality occurs in any one of the phase coils of the 3-phase brushless motor 12, the rotational driving of the motor can be continued using the two remaining phase coils.

In this case, the abnormal time motor command value calculating portion 34 calculates a composite electromotive force EMFa(θe) according to the electric angle θe with reference to a composite electromotive force calculating memory table which is used to calculate the composite electromotive force EMFa(θe) of the two normal phases;

the abnormal time motor command value calculating portion 34 calculates a phase current command value Im(θe) according to the thus calculated composite electromotive force EMFa(θe), steering assisting current command value Iref and electric angle ωe using the above-mentioned equation (4); and,

the abnormal time motor command value calculating portion 34 calculates the phase current command value of the two normal phases according to this phase current command value Im(θe) and an abnormality detect signal AS. This makes it possible to continue the rotational driving of the motor using the two normal phase coils easily and positively.

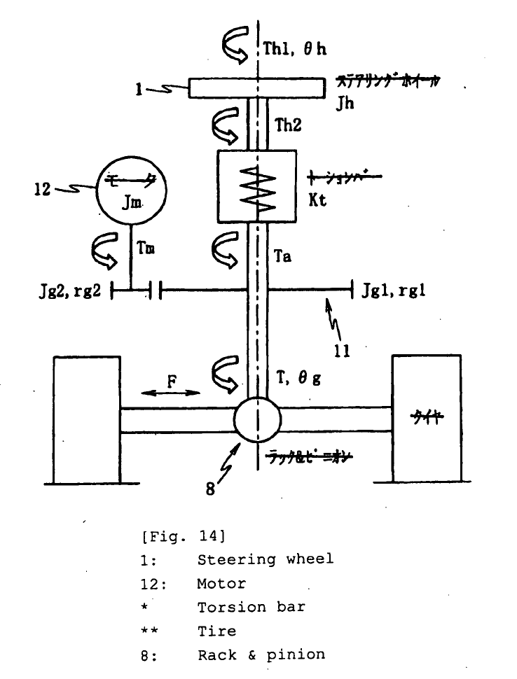

Also, since the driver is steering the steering wheel 1, even when the steering assisting torque generated in the 3-phase brushless motor 12 reduces, an electric power steering apparatus, which is used as the motor motion model of an electric power steering apparatus shown in FIG. 14, generates an inertia torque which includes: an inertia torque generated in the steering wheel 1 (=Jh·(θh)″); an inertia torque generated on the steering shaft 2 side of the reduction gear 11 (=Jg1·(θg)″); an inertia torque generated on the motor side of the reduction gear 11 (=rg1/rg2)²·Jg2·(θg)″); and, the inertia torque of the motor portion (=rg1/rg2)²·Jm·(θg)″).

The inertia torque, which is generated by the inertia (Jh, Jg1, Jg2 and Jm) of the respective portions and the acceleration (θh)″, (θg)″ of the respective portions, makes up for the reduction of the steering assisting torque generated in the 3-phase brushless motor 12. This makes it easy for the motor rotation driving operation to cope with the areas in the vicinities of the electric angles θe of 90° and 270°.

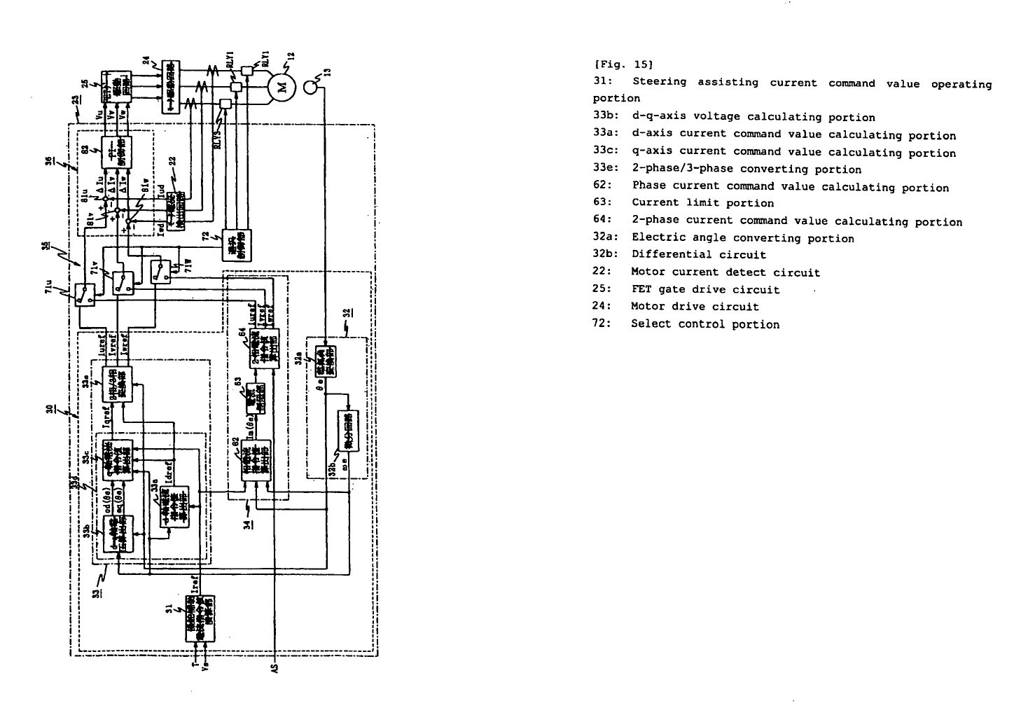

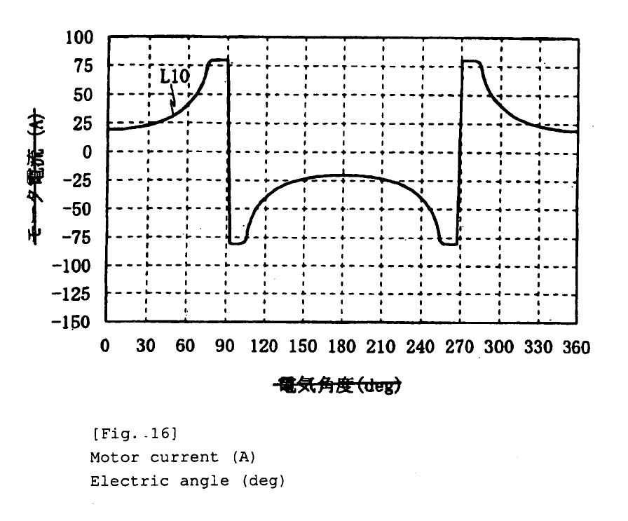

Next, description will be given below of a second embodiment according to the invention with reference to FIGS. 15 and 16.

In the second embodiment, a composite electromotive force EMFa(θe) is calculated according to an electric angle θe with reference to a composite electromotive force calculating memory table; and, instead of calculating the phase current command value Im(θe) according to the above-mentioned equation (4), when an abnormality occurs in any one of drive systems for the three phases of the 3-phase brushless motor 12, there is supplied a motor current as the function of the rotor angle.

That is, according to the second embodiment, as shown in FIG. 15, the abnormality time motor command value calculating portion 34 is different from the structure shown in FIG. 3 in that: the electromotive force calculating portion 61 is omitted; and, the phase current command value calculating portion 62 calculates a phase current command value Im(θe) according to the electric angle θe with reference to a phase current command value calculating memory table shown in FIG. 16 which is based on the steering assisting current command value Iref. However, except for the above, the second embodiment is similar in structure to FIG. 3. Therefore, the corresponding portions of the second embodiment are given the same designations of the first embodiment and thus the detailed description thereof is omitted here.

Here, the phase current command value calculating memory table, as shown in FIG. 16, provides a characteristic curve of a phase current command value Im(θe) similar to the phase current command value Im(θe) that is calculated according to the above-mentioned equation (4) in the first embodiment. Specifically, the characteristic curve L10 is set in the following manner:

the motor current increases from +20 A to 80+A in an arc projecting upwardly while the electric angle θe increases from 0° to 75°;

it maintains +80 A in the range of 75°˜90°;

it reverses down to −80 A at 90°;

after then, it maintains −80 A until 105°;

after then, it increases up to −20 A in an arc projecting upwardly until 180°;

after then, it decreases down to −80 A in an arc projecting upwardly until 255°;

it maintains −80 A from 255° toward 270°;

it reverses up to +80 A at 270 °;

after then, it maintains +80 A until 285°;

it then decreases from 285° toward 360° in a curve projecting downwardly; and,

it decreases down to +20 A at 360°.

According to the second embodiment, when the 3-phase brushless motor 12 is normal, similarly to the previously described first embodiment, phase current command values Iuref˜Iwref respectively calculated by the normal time motor command value calculating portion 33 are supplied through the select switches 71u˜71w of the command value select portion 35 to the motor current control portion 36, whereby the motor current control portion 36 carries out a feedback control according to the phase current command values Iuref˜Iwref and the motor currents Iud˜Iwd detected by the motor current detect circuit 22 to calculate voltage command values Vu˜Vw. The thus calculated voltage command values Vu˜Vw are then supplied to the FET gate drive circuit 25, whereby the FET gate drive circuit 25 drives and controls the field effect transistors of the motor drive circuit 24 to output 3 phase motor currents Iu˜Iw to the 3-phase brushless motor 12. In response to this, the 3-phase brushless motor 12 generates the optimum steering assisting force corresponding to the steering torque T and vehicle speed Vs, thereby being able to carry out the optimum steering assisting control.

However, when breakage occurs in any one of drive systems for the respective phase coils Lu˜Lw of the 3-phase brushless motor 12, for example, in the U phase, or a short occurs in the field effect transistors of the motor drive circuit 24, the phase current command value calculating portion 62 calculates the phase current command value Im(θe) according to the electric angle θe with reference to the phase current command value calculating memory table shown in FIG. 16.

And, the thus calculated phase current command value Im(θe) is supplied to the current limit portion 63. When the phase current command value Im(θe) exceeds the maximum value that can be output by the motor drive circuit 24, the maximum value of the phase current command value Im(θe) is limited to the maximum output value of the motor drive circuit 24. And, the thus current limited phase current command value Im(θe) is supplied to the 2-phase current command value calculating portion 64, thereby setting the direction of a current to be supplied from the abnormal drive system, the abnormal state of which is decided by the sign of the phase current command value Im(θe) and the abnormality detect signal As, to the two normal V and W phase coils Lv and Lw.

And, the phase current command values Ivref and Iwref calculated according to the thus set current direction are supplied through the select switches 71u˜71w to the motor current control portion 36, whereby a feedback control is carried out according to these phase current command values Ivref and Iwref and the motor currents Ivd and Iwd detected by the motor current detect circuit 22, thereby calculating two phase voltage command values Vv and Vw. And, according to these two voltage command values Vv and Vw, the FET gate drive circuit 25 drives and controls the motor drive circuit 24 using a pulse width modulation signal to thereby form similar motor currents Iv and Iw to the first embodiment, while these motor currents Iv and Iw are then supplied to the phase coils Lv and Lw of the 3-phase brushless motor 12.

In this manner, similarly to the first embodiment, when an abnormality occurs in any one of the conducting systems of the phases of the 3-phase brushless motor 12, the rotational driving of the 3-phase brushless motor 12 can be continued using the two remaining phases.

As described above, according to the second embodiment, since the phase current command value Im(θe) is calculated according to the electric angle θe with reference to the phase current command value calculating memory table, there is eliminated the need for execution of the operation processing of the above-mentioned equation (4), thereby being able to carry out the phase current command value calculating processing easily in a short time.

And, in the second embodiment as well, as described in the first embodiment, since the driver is steering the steering wheel 1, even when the steering assisting torque generated in the 3-phase brushless motor 12 reduces, the inertia torque, which is generated by the inertia (Jh, Jg1, Jg2 and Jm) of the electric power steering apparatus serving as the motion model of an electric power steering apparatus shown in FIG. 14 and also by the acceleration of the respective portions thereof, makes up for the reduction of the steering assisting torque generated in the 3-phase brushless motor. This makes it easy for the motor driving operation to deal with the areas of the vicinities of the electric angles where the steering assisting torque reduces.

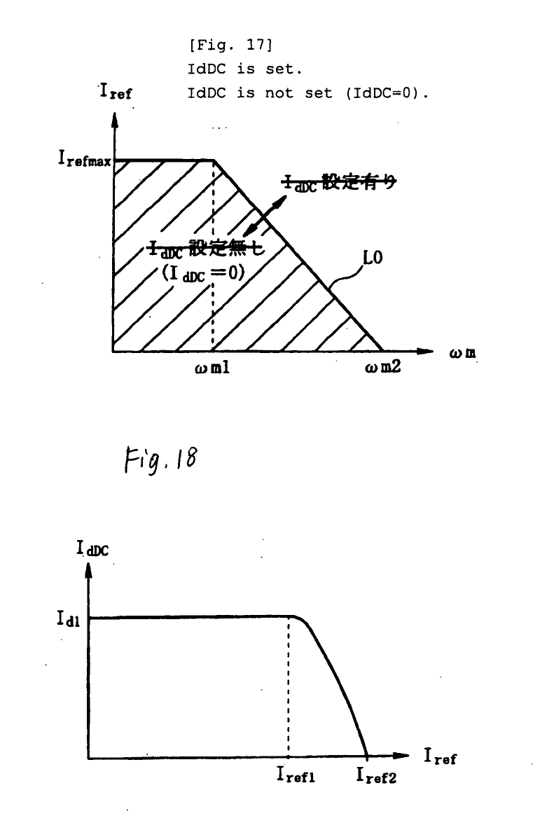

Here, in the first and second embodiments, description has been given of a case in which, in the normal time motor command value calculating portion 33, the d-axis current command value calculating portion 33a calculates the d-axis current command value Idref according to the steering assisting current command value Iref, the d-q-axis voltage calculating portion 33b calculates the d-axis voltage ed(θe) and q-axis voltage eq(θe), and the q-axis current command value calculating portion 33c operates the above-mentioned equation (3) to thereby calculate the q-axis current command value Iqref. However, this is not limitative but it is also possible to employ another structure which decides whether a d-axis direct current command value IdDC for forming a d-axis current command value Idref is set at “0” according to a motor angular velocity ωm (=ωe/p, where p: number of pairs of poles of the motor) with reference to a memory table shown in FIG. 17; or, a structure in which the d-axis direct current command value IdDC is calculated as a function based on the motor angular velocity ωm with reference to a memory table shown in FIG. 18, and then the thus decided d-axis direct current command value IdDC is set as a d-axis current command value Idref.

Also, in the first and second embodiments, description has been given of a case in which, between the respective phase coils Lu˜Lw and the motor drive circuit 24 of the 3-phase brushless motor 12, there are interposed the cutoff relays RLY1˜RLY3. But, it is also possible to omit any one of the relay contacts RLY1˜RLY3. In this case, when the field effect transistor of the upper or lower arm of the motor drive circuit 24 in the drive system including the omitted relay contact is shorted, such short abnormality cannot be dealt with; however, since there are reduced only two of the application ranges of the 2-phase driving operation of the 3-phase brushless motor in the abnormal time, there is no fear that such short abnormality raises a big problem.

Further, in the first and second embodiments, description has been given of a case in which the 2-phase/3-phase converting portion 33e is provided on the output side of the d-q-axis current command value calculating portion 33d of the normal time motor command value calculating portion 33. However, this is not limitative but it is also possible to employ another structure in which this 2-phase/3-phase converting portion 33e is omitted. Instead, motor current detect values Iud, Ivd and Iwd respectively output from the motor current detect circuit 22 are supplied to a 3-phase/2-phase converting portion to convert them to the d-axis current Idd and q-axis current Iqd of rotation coordinates; the motor current control portion 36 subtracts the d-axis current Idd and q-axis current Iqd from a d-axis current command value Idref and a q-axis current command value Iqref to calculate current deviations ΔId and ΔIq; the PI control portion 82 carries out a PI control processing on these current deviations ΔId and ΔIq to calculate a d-axis instruction voltage Vd and a q-axis instruction voltage Vq; a 2-phase/3-phase converting portion converts these d-axis instruction voltage Vd and q-axis instruction voltage Vq to three phase instruction voltages Vu, Vv and Vw; and, the three phase instruction voltages Vu, Vv and Vw are respectively supplied to the FET gate drive circuit 25. That is, the whole of the control operation unit 23 may be structured as a vector control system.

Here, the present application is based on the Japanese application (Patent Application No. 2007-172387) filed on Jun. 29, 2007 and thus the contents thereof are incorporated herein for reference.

1. An electric power steering apparatus, comprising:
a 3-phase brushless motor including star connected phase coils for generating steering assisting force for a steering system;
steering torque detect unit which detects a steering torque to be transmitted to the steering system; and,
steering assisting control unit which calculates a steering assisting current command value according to the steering torque detected by the steering torque detect unit, and which drives and controls the 3-phase brushless motor according to the thus calculated steering assisting current command value,
wherein the steering assisting control unit comprises:
coil drive system abnormality detect unit which detects a conduction abnormality of drive systems for the respective phase coils;
steering assisting current command value calculating unit which calculates the steering assisting current command value according to the steering torque;
normal time motor command value calculating unit, when the coil drive system abnormality detect unit does not detect the abnormality of the drive systems for the respective phase coils, which calculates a phase current command value for driving the three phase coils according to the steering assisting current command value;
abnormal time motor command value calculating unit, when the coil drive system abnormality detect unit detects a conduction abnormality in one of the drive systems for the respective phase coils, which calculates a phase current command value for driving the two remaining phase coils according to the steering assisting current command value; command value select unit which selects the phase current command value calculated by the normal time motor command value calculating unit or the phase current command value calculated by the abnormal time motor command value calculating unit; and,
motor control unit which drives the 3-phase brushless motor according to the phase current command value selected by the command value select unit.

2. The electric power steering apparatus as set forth in claim 1, further comprising:
conduction cutoff unit interposed between the drive systems for the respective phase coils and capable of cutting off conduction between the phase coil drive systems; and,
cutoff control unit, when the coil drive system abnormality detect unit detects the conduction abnormality in one of the phase coil drive systems, which controls the conduction cutoff unit, which is interposed between the drive systems including the drive system detected abnormal, to cut off conduction between these drive systems.

3. The electric power steering apparatus as set forth in claim 1, wherein
the abnormal time motor command value calculating unit, when controlling the two phase coils into conduction, sets the phase current command value as a function of a rotor angle.

4. The electric power steering apparatus as set forth in claim 1, further comprising:
electric angle information calculating unit which detects a motor rotation angle to calculate an electric angle and an electric angular velocity,
wherein the normal time motor command value calculating unit includes at least:
a d-axis current setting unit which sets a d-axis current;
a d-q voltage calculating unit which calculates a d-axis voltage and a q-axis voltage while referring to a 3-phase driving memory table expressing a relationship between d-axis voltage, q-axis voltage and electric angle respectively obtained by converting electromotive force waveforms of three coils to a rotor rotation coordinate system; and,
q-axis current calculating unit which calculates a q-axis current according to the steering assisting current command value, d-axis voltage, q-axis voltage, d-axis current and electric angular velocity.

5. The electric power steering apparatus as set forth in claim 1, further comprising:
electric angle information calculating unit which detects a motor rotation angle to calculate an electric angle and an electric angular velocity,
wherein the abnormal time motor command value calculating unit includes:
electromotive force calculating unit which calculates an electromotive force while referring to a two-phase driving memory table expressing a relationship between an electromotive force and an electric angle obtained from the composite value of the electromotive force waveforms of the two normal phase coils; and,
phase current command value calculating unit which calculates the phase current command values of the two phases according to the steering assisting current command value, electric angular velocity and the electromotive force.
